(19) United States
(12) Patent Application Publication
(10) Pub. No.: US 2007/0189948 A1
(43) Pub. Date: Aug. 16, 2007

(54) Catalyst system and method

(76) Inventors: Teresa Grocela Rocha, Clifton Park, NY (US); John Dewey Blouch, Glenville, NY (US); Don Hancu, Clifton Park, NY (US); Narendra Digamber Joshi, Cincinatti, OH (US); Jonathan Lloyd Male, Schoharie, NY (US); Alison Liana Palmatier, Porter Corners, NY (US); Benjami Rue Wood, Niskayuna, NY (US)

Correspondence Address: Patrick S. Yoder;FLETCHER YODER, P.O. Box 692289, Houston, TX, 77269-2289, US

(21) Appl. No.: 11/353,310

(22) Filed: Feb. 14, 2006

(51) Int. Cl. B01D 53/46; B01D 47/00

(52) U.S. Cl. 423/210; 502/527.23

(57) ABSTRACT

In accordance with one embodiment of the present invention, a catalyst system is provided. The catalyst system includes a catalyst bed that comprises a plurality of catalyst segments arranged such that an exhaust flow passes along a longitudinal axis of the catalyst system through the plurality of catalyst segments from a first one of the plurality of catalyst segments through a last one of the plurality of catalyst segments, each of the plurality of catalyst segments comprising a plurality of catalytic cells, wherein a concentration of catalytic material decreases from the first one of the plurality of catalyst segments through the last one of the plurality of catalyst segments.

### BACKGROUND

The present invention relates generally to processing exhaust gases from turbine devices and, in particular, to processing such gases to reduce emissions of oxides of nitrogen (NOₓ) by employing selective catalytic reduction (SCR) devices.

In traditional gas turbine devices, air is drawn from the environment, mixed with fuel and, subsequently, ignited to produce combustion gases, which may be used to drive a machine element or to generate power, for instance. Traditional gas turbine devices generally include three main systems: a compressor, a combustor and a turbine. The compressor pressurizes air and sends this air towards the combustor. The compressed air and a fuel are delivered to the combustor. The fuel and air delivered to the combustor are ignited, with the resulting combustion gases being employed to actuate a turbine or other mechanical device. When used to drive a turbine, the combustion gases flow across the turbine to drive a shaft that powers the compressor and produces output power for powering an electrical generator or for powering an aircraft, to name but a few examples.

Gas turbine engines are typically operated for extended periods of time, and exhaust emissions from the combustion gases are a concern. For example, during combustion, nitrogen combines with oxygen to produce NOₓ emissions. Such NOₓ emissions are often subject to regulatory limits and are generally undesired. Traditionally, gas turbine devices reduce the amount of NOₓ emissions by decreasing the fuel-to-air ratio, and these devices are often referred to as lean devices. Lean devices reduce the combustion temperature within the combustion chamber and, in turn, reduce the amount of NOₓ emissions produced during combustion.

An additional method of reducing NOₓ emissions from turbine systems includes passing turbine exhaust gasses through catalytic devices, such as SCR devices. Catalytic devices facilitate a chemical interaction between NOₓ emissions and additional reactant and catalytic materials. This chemical interaction causes the NOₓ emissions to be transformed into byproducts that do not have the undesirable properties of the NOₓ emissions themselves.

In SCR catalyst systems, it is generally desirable to minimize the drop of pressure of the turbine exhaust gases while they are interacting with the SCR catalytic material. By minimizing the pressure drop, turbine performance is generally improved. A system that allows improved efficiency of processing NOₓ emissions while reducing pressure drop of turbine emissions is desirable.

### BRIEF DESCRIPTION

Briefly, in accordance with one embodiment of the present invention, a catalyst system is provided. The catalyst system includes a catalyst bed that comprises a plurality of catalyst segments arranged such that an exhaust flow from a turbine passes along a longitudinal axis of the catalyst system through the plurality of catalyst segments from a first one of the plurality of catalyst segments through a last one of the plurality of catalyst segments, each of the plurality of catalyst segments comprising a plurality of catalytic cells, wherein a density of catalytic cells decreases for each successive catalyst segment from the first one of the plurality of catalyst segments through the last one of the plurality of catalyst segments.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a gas turbine system, in accordance with an exemplary embodiment of the present invention;

FIG. 2 is a diagrammatic representation of an SCR catalyst system in which exemplary embodiments of the present invention may be implemented;

FIG. 3 is a diagrammatic representation of an SCR catalyst system in accordance with an exemplary embodiment of the present invention;

FIG. 4 is a diagrammatic representation of an SCR catalyst system in accordance with an alternative exemplary embodiment of the present invention;

FIG. 5 is a diagram showing an exemplary NOₓ concentration profile in accordance with an exemplary embodiment of the present invention;

FIG. 6 is a graphical representation that shows an exemplary average NOₓ concentration in accordance with an exemplary embodiment of the present invention;

FIG. 7 is a diagrammatic representation of an SCR catalyst system in accordance with another alternative exemplary embodiment of the present invention;

FIG. 8 is a graphical representation that shows an exemplary average NOₓ concentration in accordance with the exemplary embodiment of the present invention illustrated in FIG. 7.

### DETAILED DESCRIPTION

As a preliminary matter, the definition of the term “or” for the purpose of the following discussion and the appended claims is intended to be an inclusive “or.” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A”, by itself “B” by itself and any combination thereof, such as “AB” and/or “BA.”

Exemplary embodiments of the present invention are believed to improve the performance of a catalyst bed. In particular, embodiments of the present invention relate to hydrocarbon SCR (HC-SCR) catalyst systems but are not limited to and could allow this new technology to be used in ammonia or urea SCR systems. In such systems, it is desirable to maximize interaction of the HC-SCR catalyst with NOₓ emissions in throughout the catalyst bed). It is additionally desirable to minimize other system design criteria such as pressure drop of turbine emissions, temperature and NOₓ concentration gradients. Other examples of potentially undesirable reactants include carbon monoxide (CO), unburned hydrocarbons and the like. Those of ordinary skill in the art will appreciate the embodiments of the present invention may be adapted to reduce concentrations of one or more of these components, as well as NOₓ.

In an exemplary embodiment of the present invention, catalyst geometry, including cell size and dividing the catalytic bed into segments are used to improve the processing of NOₓ emissions. Turbine exhaust stream may be mixed more efficiently, with a concomitant reduction in contact time for catalytic segments. In other words, efficient mixing desirably facilitates reduction of contact time and pressure drop. This exploits a maximum rate of conversion of NOₓ emissions at a front section of a catalytic bed. At the same time, other design criteria such as reduction in flow stream pressure, temperature, and concentration gradients through the bed along a primary axis of flow may be minimized. Factors that affect the desired reactant concentration gradient include kinetic rate of the catalytic reaction or mass transfer rate to the edge of the channel.

Alternative embodiments of the present invention may employ a narrowing geometry of the catalyst bed. Other embodiments may employ a split bed with air spaces or inert ceramics to improve mixing between the various catalytic segments. The catalytic cells of each segment of monolith material may be rotated around an axis of flow to increase mixing. The monolith material has a cellular structure within which the catalytic material is supported. In one embodiment, successive catalytic stages employ a decreasing density of catalytic material by reducing the number of catalytic cells per square inch across segments as flow proceeds from the entry of a catalyst bed to its exit. This is not to say that each segment necessarily has a lower cell density than the preceding segment, but that the cell density decreases from the first segment in the catalytic bed to the last segment. In another embodiment, each segment of the catalytic bed may employ a lower concentration (density) of active metals as progression through the segments occurs, even though cell density from one segment to the next may increase. In yet another embodiment, the reduction in reactant concentration through the segments may be achieved through the use of varied amounts of washcoat support through the segments of the catalyst.

Embodiments of the present invention improve processing efficiency of NOₓ conversion in SCR catalytic systems. Either the length of the catalyst bed or the pressure drop per unit length may be reduced, which minimizes pressure drop and cost of the catalyst.

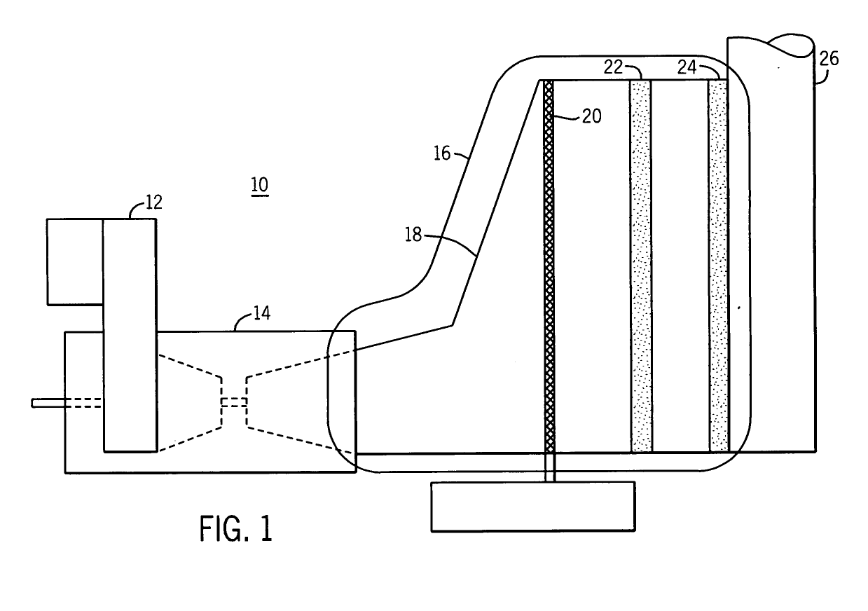

Turning now to the drawings, FIG. 1 is a diagrammatic representation of a gas turbine system, in accordance with an exemplary embodiment of the present invention. The gas turbine system is generally referred to by the reference number 10. An air filter 12 is used to filter air that is being input into a gas turbine package 14. Exhaust from the gas turbine package 14 is delivered to a catalyst package 16. The catalyst package 16 may include an exhaust diffuser 18 and a reductant injection grid 20. A NOₓ catalyst bed 22 is intended to interact with exhaust gasses from the turbine package 14. Further, processing of the exhaust gasses is performed by a CO oxidation catalyst 24. Finally, the processed turbine emission gasses are delivered to a stack 26.

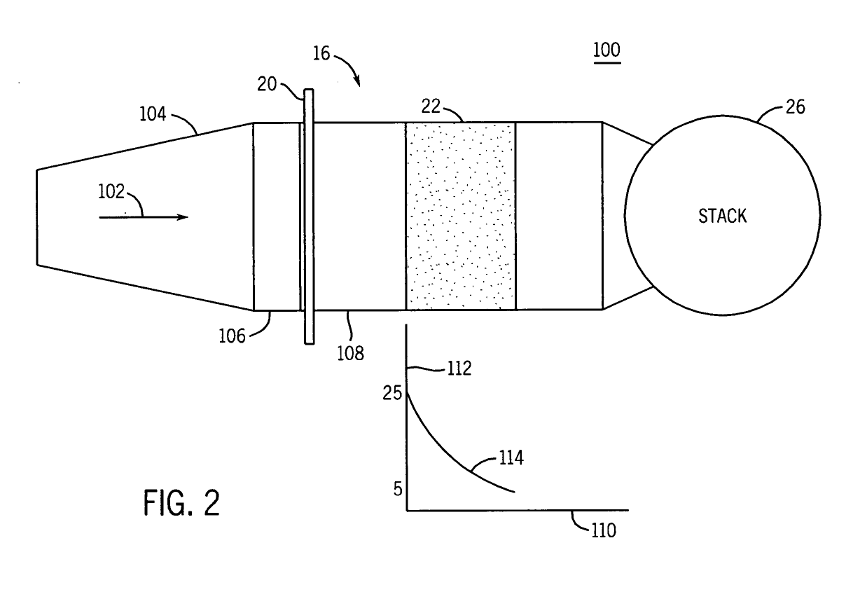

FIG. 2 is a diagrammatic representation of an SCR catalyst system in which exemplary embodiments of the present invention may be employed. The SCR catalyst system is generally referred to by the reference number 100. An exhaust flow from a previous turbine stage is illustrated by an arrow 102. The exhaust flow 102 passes through an exhaust diffuser 104 and a flow straightener 106 before interacting with a reductant injector grid 20, as illustrated in FIG. 1. Next, the exhaust flow 102 passes through a reductant mixing section 108. The exhaust flow 102 thereafter passes through a catalyst bed 22 before being delivered to a stack 26.

As illustrated by an exemplary graph below the catalyst bed 22, the average NOₓ concentration profile drops sharply as the exhaust flow 102 passes through the catalyst bed 22. An x-axis 110 represents distance through the catalyst bed 22. A y-axis 112 represents a magnitude of NOₓ concentration. An average NOₓ concentration profile 114 illustrates a precipitous drop in average NOₓ concentration as the exhaust flow 102 passes through the catalyst bed 22.

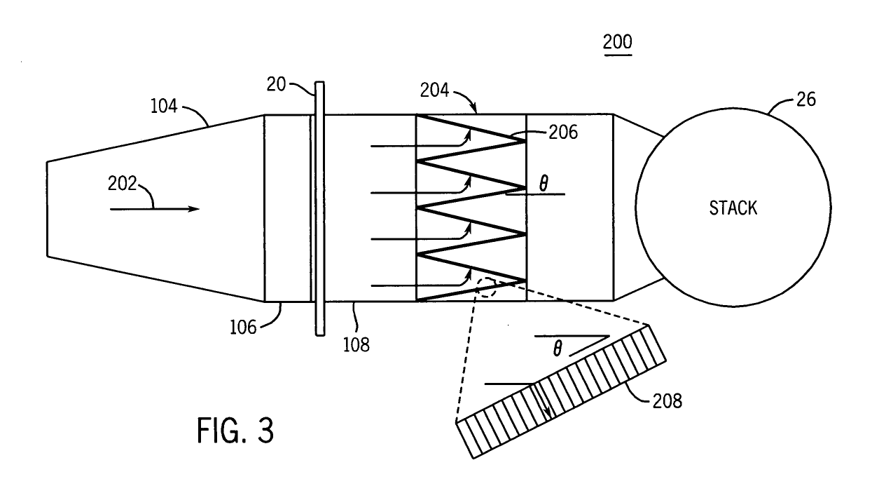

FIG. 3 is a diagrammatic representation of an SCR catalyst system in accordance with an exemplary embodiment of the present invention. The catalyst system illustrated in FIG. 3 is generally referred to by the reference numeral 200. An exhaust flow from a previous turbine stage is illustrated by an arrow 202. The exhaust flow 202 passes through an exhaust diffuser 104, a flow straightener 106 and a reductant injection grid 20 before being delivered by a reductant mixing section 108 to a catalyst bed 204.

The catalyst bed 204 comprises a number of catalyst grid sections 206, as illustrated in FIG. 3. Each of the catalyst grid sections 206 is disposed at an angle θ relative to a longitudinal axis of the catalyst system 200. The angle θ may desirably be less than 90 degrees. By placing the catalyst grid sections 206 at an angle θ relative to the longitudinal axis of the SCR catalyst system 200, surface area of the catalyst bed is increased relative to systems in which the exhaust flow 202 is perpendicular to the catalyst grids. Moreover, the length of each of the catalyst grid sections 206 approximates the hypotenuse of a triangle formed by a line coexistent with the longitudinal axis of the SCR catalyst system 200 and a perpendicular projection of that line at the angle θ relative thereto.

A breakout section of catalyst grade 208 is illustrated in FIG. 3. The breakout section of catalyst grid 208 illustrates the interaction of the exhaust flow 202 with each of the catalyst grid sections 206 at the angle θ.

As illustrated in FIG. 3, the catalyst grid sections 206 are arranged in a plurality of v-shaped sections. This configuration is believed to be effective to reduce NOₓ emissions while reducing the pressure drop through the catalyst system. Design considerations for such a system include potential trade-offs between a pressure drop of the flow as it enters a monolith channel, a pressure drop along the channel and a pressure drop at an exit of the monolith channel. The pressure drop associated with entering and exiting the monolith channel may increase as the angle of incidence of the flow to the monolith channel increases. The pressure drop along the monolith channel may decrease as the angle of incidence of the flow to the monolith channel increases.

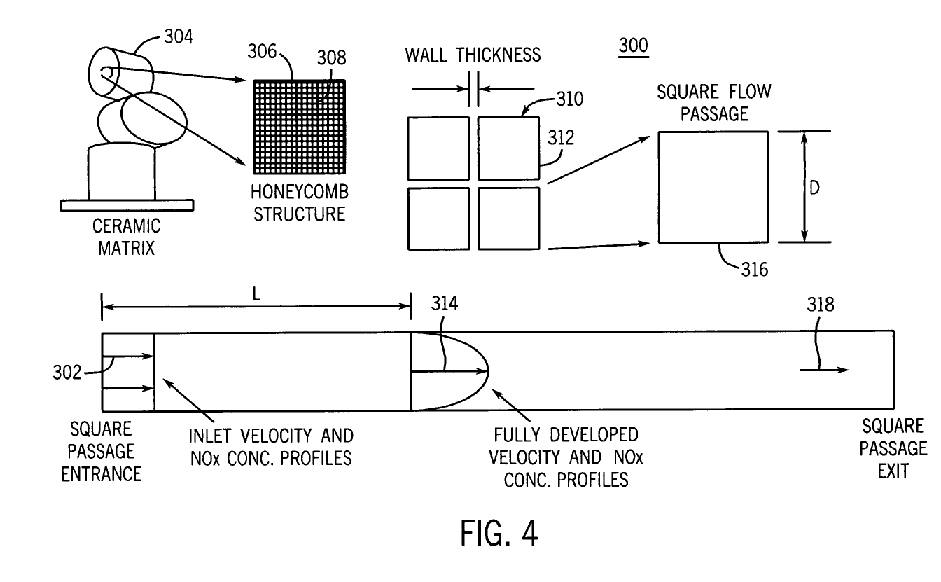

FIG. 4 is a diagrammatic representation of an SCR catalyst system in accordance with an alternative exemplary embodiment of the present invention. The SCR catalyst system illustrated in FIG. 4 is generally referred to by the reference number 300. An exhaust flow from a previous turbine stage is indicated by an arrow 302. The exhaust flow first encounters a ceramic matrix 304, which may comprise geometric structures coated with a monolithic catalytic material. The ceramic matrix 304 may have a honeycomb-shaped cross section 306. The honeycomb cross section may present a plurality of catalyst elements 308 to the exhaust flow 302.

When the exhaust flow 302 has passed a distance L into the catalyst system 300, it encounters a secondary catalyst matrix 310. The secondary catalyst matrix 310 is comprised of a plurality of secondary catalyst elements 312. As illustrated in FIG. 4, the secondary catalyst matrix 310 has a lower concentration of catalyst elements 312 per surface area than does the honeycomb structure 306. The flow through the secondary catalyst elements 308 is illustrated by an arrow 314. After passing through the secondary catalyst matrix 310, the flow 314 passes finally to a square passage 316. The exhaust flow exits the catalyst system 300, as illustrated by an arrow 318.

Other embodiments may include the implementation of different geometries in the catalyst beds. For example, a first bed may employ catalyst segments that have square channels, a second bed may employ catalyst segments having triangular channels, and a third bed may employ catalyst segments having hexagonal channels.

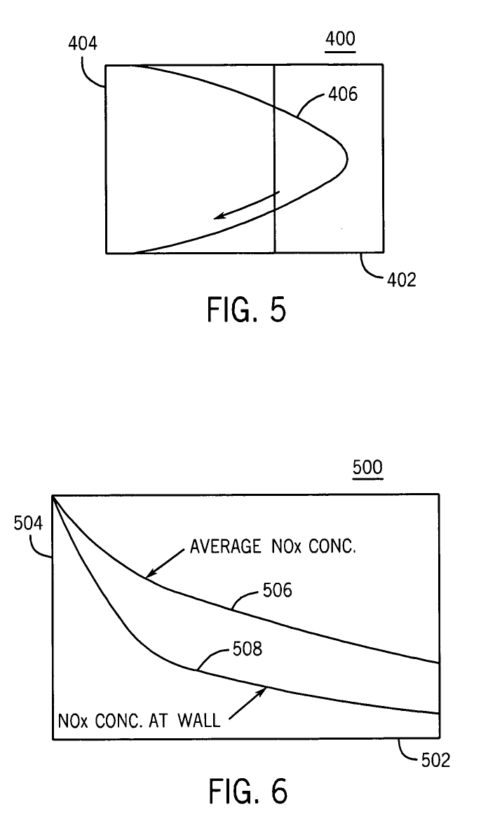

FIG. 5 is a diagram showing an exemplary NOₓ concentration profile in accordance with an exemplary embodiment of the present invention. The diagram is generally referred to by the reference number 400. FIG. 5 illustrates that a NOₓ concentration profile at each passage of a catalyst, such as the catalyst system illustrated in FIG. 4, is less along the walls of the passage than at the center. A NOₓ profile 406 is a representation of a concentration of NOₓ across the profile of a catalyst bed. From an entry point 404, the NOₓ concentration along a catalyst bed wall 402 is less than the concentration toward the center of the catalyst bed. Moreover, the NOₓ concentration at the wall of the catalyst chamber is significantly lower than the average concentration in the passage. NOₓ transport to the wall is by molecular diffusion.

An exemplary embodiment of the invention may act to reduce or minimize the difference between the NOₓ concentration at the wall of the chamber and the average NOₓ concentration. The monoliths catalyze (increase the rate of) the conversion of NOₓ to N₂ while selectively allowing the reactant to interact with the active site and NOₓ and not simply combust. In order for catalysis to occur, it is desirable for the NOₓ to interact with the walls of the monolith. The rate of reaction of NOₓ to N₂ will be greater for higher concentrations of NOₓ. It is, therefore, desirable that the concentration of NOₓ at the walls of the monolith be as high as possible to ensure a high rate of reaction. If the rate of reaction of NOₓ to N₂ is much higher than the rate of axial diffusion from the center of the channel to the walls of the monolith, the gas near the walls of the monolith will rapidly be depleted of NOₓ, and the rate of NOₓ to N₂ will decrease. Thus, embodiments of the present invention desirably act to maximize NOₓ and reactant concentrations at the channel walls.

FIG. 6 is a graphical representation that shows an exemplary average NOₓ concentration in accordance with an exemplary embodiment of the present invention. The graph is generally referred to by the reference number 500. An x-axis 502 represents a distance into the catalyst segment or passage. A y-axis 504 represents a magnitude of NOₓ concentration. A trace 506 is indicative of an average NOₓ concentration in the passage. A second trace 508 is indicative of the NOₓ concentration at the wall of the passage. As illustrated in FIG. 6, the NOₓ concentration at the wall of the passage is lower than the average NOₓ concentration in the chamber.

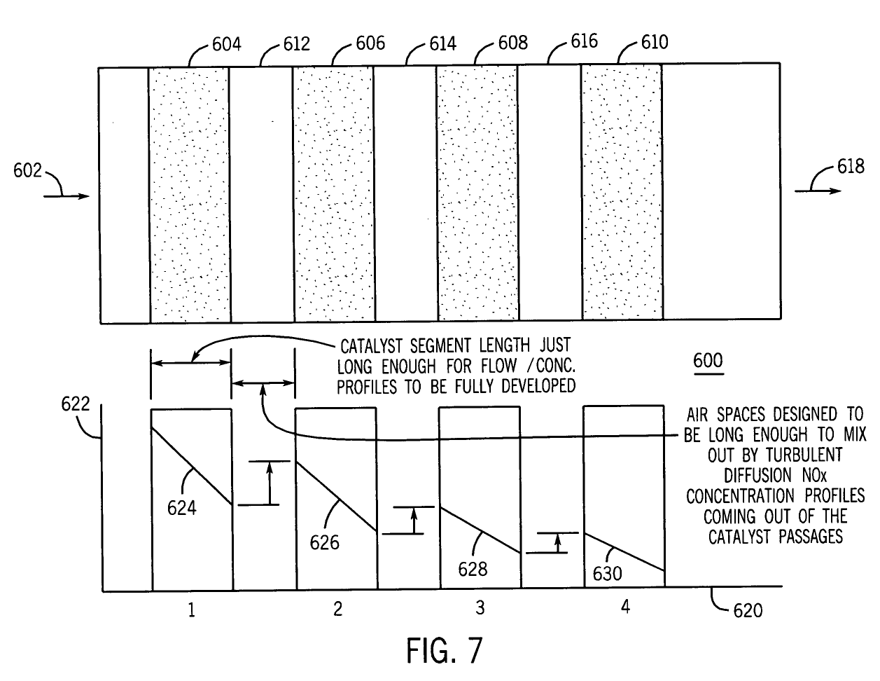

FIG. 7 is a diagrammatic representation of an SCR catalyst system in accordance with another alternative exemplary embodiment of the present invention. The catalytic system is generally referred to by the reference number 600. An exhaust flow from a prior turbine stage is illustrated by an arrow 602. The embodiment illustrated in FIG. 7 employs a plurality of catalyst segments 604, 606, 608, 610. The catalyst segments 604, 606, 608, and 610 are separated by gaps 612, 614, and 616. The gaps 612, 614 and 616 may be occupied by air or inert ceramics, for example. Those of ordinary skill in the art will appreciate that the specific number of catalyst segments in air gaps is not an essential feature of the present invention. Moreover, the specific number of catalyst segments and air gaps may be determined according to design considerations for specific systems. After passing through the catalyst segments 604, 606, 608, 610, and the air gaps 612, 614 and 616, the exhaust flow is delivered to a stack, as illustrated by an arrow 618. As set forth above, the catalyst segments 604, 606, 608 and 610 may employ a decreasing density of catalytic material. By way of example, the catalyst segment 610 may have a lower density of catalytic material or catalytic cells (or both) than the catalyst segment 604. Reduction of the catalytic material may be accomplished by using less catalytic material dosed onto the support. Additionally, wash coat thickness underlying the catalyst may be reduced.

The graph at the lower portion of FIG. 7 illustrates a successive reduction in NOₓ emissions as the exhaust flow 602 passes through the catalyst system 600. An x-axis 620 represents a distance passed through the catalyst system 600. A y-axis 622 represents a concentration of NOₓ emissions. A trace segment 624 illustrates the drop in NOₓ concentration as the exhaust flow 602 passes through the first catalytic segment 604. In an exemplary embodiment of the invention, the length of the first catalytic segment 604 is just long enough for concentration profiles to be fully developed. In an alternative exemplary embodiment, the length of the first catalytic segment 604 is just long enough that the rate of reaction becomes mass transfer limited. The airspaces between the catalytic segments should be long enough to mix out by turbulent diffusion the NOₓ concentration profiles coming out of the catalyst passages.

A partial trace 626 shows the drop in NOₓ concentration as the flow 602 passes through the second catalytic stage 606. A partial trace 628 shows the drop in NOₓ emissions as the exhaust flow 602 passes through the third catalytic stage 608. Finally, a partial trace 630 shows the drop in NOₓ emissions as the exhaust flow 602 passes through the fourth catalytic stage 610.

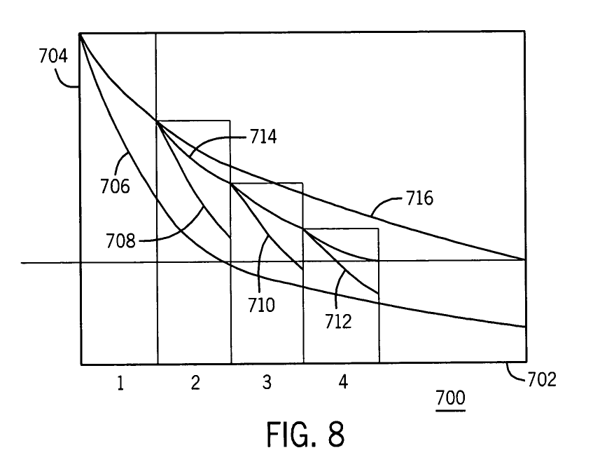

FIG. 8 is a graphical representation that shows an exemplary average NOₓ concentration in accordance with the exemplary embodiment of the present invention illustrated in FIG. 7. The graph is generally referred to by the reference number 700. An x-axis 702 represents a distance traveled by the exhaust flow 602 (FIG. 7). A y-axis 704 illustrates a magnitude of NOₓ concentration. A trace 706 illustrates the NOₓ concentration of each segment. A trace 716 illustrates the average NOₓ concentration within the chamber. As shown by a plurality of line segments 708, 710 and 712, the average NOₓ concentration is reduced through each stage of the catalyst system. In FIG. 8, the trace 708 represents a drop in average NOₓ concentration through the second catalyst stage 606 (FIG. 7). The line segment 710 represents the drop in average NOₓ concentration through the third catalyst segment 608 (FIG. 7). Finally, the line segment 712 represents the drop in average NOₓ concentration through the fourth catalyst stage 610 (FIG. 7).

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A catalyst system, comprising:
a catalyst bed that comprises a plurality of catalyst segments arranged such that an exhaust flow passes along a longitudinal axis of the catalyst system through the plurality of catalyst segments from a first one of the plurality of catalyst segments through a last one of the plurality of catalyst segments, each of the plurality of catalyst segments comprising a plurality of catalytic cells, wherein a concentration of catalytic material decreases from the first one of the plurality of catalyst segments through the last one of the plurality of catalyst segments.

2. The catalyst system as recited in claim 1, wherein each of the plurality of catalyst segments comprises a selective catalytic reduction (SCR) catalyst.

3. The catalyst system as recited in claim 1, wherein a gap is disposed between at least two of the plurality of catalyst segments.

4. The catalyst system as recited in claim 3, wherein the gap is occupied by air.

5. The catalyst system as recited in claim 3, wherein the gap is at least partially occupied by inert ceramic material.

6. The catalyst system as recited in claim 3, wherein the gap has a length sufficient to mix out a reactant concentration profile by turbulent diffusion as the exhaust flow passes through the gap.

7. The catalyst system as recited in claim 1, wherein the first one of the plurality of catalyst segments has a length sufficient to permit a reactant concentration profile to be fully developed as the exhaust flow passes through the first one of the plurality of catalyst segments.

8. The catalyst system as recited in claim 1, wherein the first one of the plurality of catalyst segments has a length just sufficient that the rate of reaction becomes mass transfer limited therein.

9. The catalyst system as recited in claim 1, comprising a stack that is adapted to receive an output flow from the catalyst bed.

10. The catalyst system as recited in claim 1, wherein the at least one catalyst segment comprises a monolithic material having a cellular structure within which the catalytic material is supported.

11. The catalyst system as recited in claim 1, wherein the plurality of cells comprising the first one of the plurality of catalyst segments each has a square cross section.

12. The catalyst system as recited in claim 10, wherein a plurality of cells comprising a second one of the plurality of catalyst segments each has a triangular cross section.

13. The catalyst system as recited in claim 1, wherein the plurality of cells comprising the last one of the plurality of catalyst segments each has a hexagonal cross section.

14. A catalyst system, comprising:
a catalyst bed that comprises at least one catalyst grid, the catalyst grid being disposed at an angle of incidence of less than 90 degrees relative to a longitudinal axis of the catalyst system.

15. The catalyst system as recited in claim 14, wherein the catalyst grid comprises a selective catalytic reduction (SCR) catalyst.

16. The catalyst system as recited in claim 14, wherein the at least one catalyst bed comprises a plurality of catalyst grids, each of the catalyst grids disposed at an angle of incidence of less than 90 degrees relative to the longitudinal axis of the catalyst system.

17. The catalyst system as recited in claim 16, wherein the plurality of catalyst grids are arranged in a plurality of v-shaped segments relative to the longitudinal axis of the catalyst system.

18. The catalyst system as recited in claim 14, wherein the catalyst system is adapted to receive an exhaust flow from a turbine in a direction coincident with the longitudinal axis of the catalyst system.

19. The catalyst system as recited in claim 14, comprising a stack that is adapted to receive an output flow from the catalyst bed.

20. The catalyst system as recited in claim 14, wherein at least one catalyst grid comprises a monolithic material having a cellular structure within which the catalytic material is supported.

21. A method of processing an exhaust flow, the method comprising:
passing the exhaust flow through a reductant injection grid;
passing the exhaust flow through a first catalyst segment having a first concentration of catalytic material;
passing the exhaust flow through a subsequent catalyst segment having a second concentration of catalytic material, the concentration of catalytic material being lower then the first concentration of catalytic material.

22. The method as recited in claim 21, wherein the catalyst segment comprises a selective catalytic reduction (SCR) catalyst.

23. The method as recited in claim 21, wherein the first one of the catalyst segments has a length sufficient to permit a reactant concentration profile to be fully developed as the exhaust flow passes through the first one of the catalyst segments.

24. The method as recited in claim 21, wherein the first one of the plurality of catalyst segments has a length just sufficient that the rate of reaction becomes mass transfer limited therein.

25. The method as recited in claim 21, comprising passing the exhaust flow through a gap disposed between the first catalyst segment and the second catalyst segment.

26. The method as recited in claim 25, wherein the gap is occupied by air.

27. The catalyst system as recited in claim 25, wherein the gap is at least partially occupied by inert ceramic material.

28. The method as recited in claim 21, wherein the gap has a length sufficient to mix out a reactant concentration profile by turbulent diffusion as the exhaust flow passes through the gap.
